(19) United States
(12) Patent Application Publication
(10) Pub. No.: US 2025/0383980 A1
(43) Pub. Date: Dec. 18, 2025

(54) SORTING SHIFT REGISTER, OS-CFAR DEVICE, AND OS-CFAR CONTROL METHOD

(71) Applicant: ELECTRONICS AND TELECOMMUNICATIONS RESEARCH INSTITUTE, Daejeon (KR)

(72) Inventor: Youngseok BAEK, Daejeon (KR)

(73) Assignee: ELECTRONICS AND TELECOMMUNICATIONS RESEARCH INSTITUTE, Daejeon (KR)

(21) Appl. No.: 19/201,013

(22) Filed: May 7, 2025

(30) Foreign Application Priority Data
Jun. 14, 2024 (KR) 10-2024-0077515

(51) Int. Cl. G06F 12/02

(52) U.S. Cl. CPC G06F 12/0223; G06F 2212/1021

(57) ABSTRACT

Provided is a sorting shift register including a plurality of unit blocks connected in a pipeline structure and configured to receive a new data value and a data value to be deleted in parallel and an external comparator configured to compare the new data value and the data value to be deleted. Each of the unit blocks includes a register, a first comparator configured to compare the new data value with an internal data value of the register, a second comparator configured to compare the data value to be deleted with the internal data value, and a multiplexer configured to selectively store, in the register, one of the internal data value, the new data value, and a data value of a unit block on the left or right of the unit block in accordance with comparison results of the external comparator, the first comparator, and the second comparator.

### CROSS-REFERENCE TO RELATED APPLICATION

This application claims priority to and the benefit of Korean Patent Application No. 10-2024-0077515, filed on Jun. 14, 2024, the disclosure of which is incorporated herein by reference in its entirety.

### BACKGROUND

### 1. Field of the Invention

Various exemplary embodiments disclosed in the present document relate to radar detection technology.

### 2. Discussion of Related Art

A radar system transmits a radar signal and receives and processes a signal reflected by a target to detect the target. A reflected signal includes the signal reflected by the target (hereinafter, “target signal”) and clutter caused by terrain features.

To distinguish between a target and clutter in a reflected signal, a radar system uses a fast Fourier transform (FFT) algorithm to determine signals of each of frequency components as input cell data and identify a signal which is greater than a threshold among cell values as a target. When the threshold is set low in the radar system, clutter may be incorrectly detected as a target, and when the threshold is set high, a target may not be identified.

To prevent these problems, a radar system utilizes a constant false alarm rate (CFAR) algorithm that variably applies a threshold in accordance with circumstances to keep a misdetection rate constant. The CFAR algorithm estimates a noise level of a nearby cell (reference cell) of a cell under test (CUT) and determines a threshold on the basis of the noise level. According to the CFAR algorithm, the determined threshold is compared with a signal intensity of the CUT, which allows a determination on whether the signal intensity of the CUT corresponds to a target signal.

However, the CFAR algorithm has a target-masking effect and the problem of clutter edges and thus is not suitable for a road environment with big target movements.

To prevent this problem, ordered statistic (OS)-CFAR algorithm has been disclosed. An OS-CFAR algorithm sorts received signals of nearby cells and then determines a threshold for the number of positions of a specific turn.

FIG. 1 is a diagram illustrating operations of an OS-CFAR device.

In operation 110, the OS-CFAR device stores N pieces of range data in a shift register and sequentially scans the N pieces of range data using a sliding window.

In operation 120, the OS-CFAR device sorts the scanned range data (amplitude values) in descending order and selects a k^{th} cell Xₖ.

In operation 130, the OS-CFAR device calculates an adaptive threshold (Z=B·Xₖ) by multiplying the selected k^{th} cell Xₖ. by a scaling coefficient B through a multiplier 140.

In operation 140, to determine whether a CUT is a target, the OS-CFAR device compares a CUT value with the adaptive threshold Z through a comparator. When the CUT value is larger than the threshold value Z, the OS-CFAR device determines the CUT as a target. On the other hand, when the CUT value is smaller than the threshold value Z, the OS-CFAR device determines that the CUT is not a target.

The OS-CFAR device may find Xₖ which is a k^{th} piece of data among reference window cells using a data sorting algorithm. Generally used simple sorting algorithms, such as bubble sort, involve M*M comparison computations for sorting, and fast sorting algorithms, such as quick sort, require M log M comparison computations.

### SUMMARY OF THE INVENTION

As described above, a sorting operation of an ordered statistic constant false alarm rate (OS-CFAR) algorithm requires many computations, which may lead to a long processing time, and hardware-based parallel processing may consume less processing time but may require many hardware resources. Further, an OS-CFAR device according to the related art sorts all newly incoming range data at every clock, which increases a processing time or required resources.

This disclosure is directed to providing a sorting shift register for sorting data on the basis of a pipeline-structured hardware device, an OS-CFAR device, and an OS-CFAR control method.

The is disclosure is also directed to providing a sorting shift register for determining k^{th} data in a plurality of sorting blocks through a small number of comparisons, an OS-CFAR device, and an OS-CFAR control method.

According to an aspect of the present invention, there is provided a sorting shift register including a plurality of unit blocks connected in a pipeline structure and configured to receive a new data value and a data value to be deleted in parallel and an external comparator configured to compare the new data value and the data value to be deleted. Each of the unit blocks includes a register, a first comparator configured to compare the new data value with an internal data value of the register, a second comparator configured to compare the data value to be deleted with the internal data value, and a multiplexer configured to selectively store, in the register, one of the internal data value, the new data value, and a data value of a unit block on the left or right of the unit block in accordance with comparison results of the external comparator, the first comparator, and the second comparator.

According to another aspect of the present invention, there is provided an OS-CFAR device including a shift register configured to store more than N data values received by a radar, a first sorting shift block configured to generate a first sorted list by sorting N/2 data values from a first reference window near a cell under test (CUT) in the shift register, a second sorting shift block configured to generate a second sorted list by sorting N/2 data values from a second reference window near the CUT, and a selector configured to select a k^{th} data value for determining the CUT on the basis of a result of comparing a minimum value and a maximum value included in a first partial list of the first sorted list and a second partial list of the second sorted list.

According to another aspect of the present invention, there is provided an ordered statistic (OS)-constant false alarm rate (CFAR) control method comprising: acquiring first and second data values from first and second reference windows near a cell under test (CUT) in a shift register; separately sorting the acquired first and second data values to generate first and second sorted lists; extracting a first partial list and a second partial list from the first and second sorted lists, respectively; and selecting a k^{th} data value for determining the CUT on the basis of a comparison result between a minimum value of the first partial list and a maximum value of the second partial list.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram illustrating operations of an ordered statistic-constant false alarm rate (OS-CFAR) device;

FIG. 2 is a configuration diagram of an OS-CFAR device according to an exemplary embodiment;

FIG. 3 is a configuration diagram of a sorting shift block according to an exemplary embodiment;

FIG. 4 is a configuration diagram of unit blocks in a sorting shift block according to an exemplary embodiment;

FIG. 5 is a conceptual diagram illustrating an operation of a sorting shift block in a first state of a shift register;

FIG. 6 is a conceptual diagram illustrating an operation of a sorting shift block in a third state of a shift register;

FIGS. 7 and 8 are conceptual diagrams illustrating operations of a sorting shift block in a second state of a shift register;

FIG. 9 is a diagram illustrating a method of selecting a k^{th} data value through a selector according to an exemplary embodiment; and

FIG. 10 is a flowchart illustrating an OS-CFAR algorithm execution method according to an exemplary embodiment.

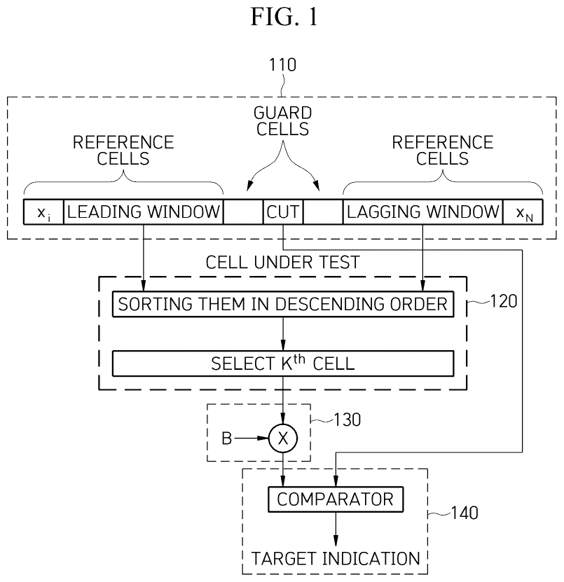

In relation to the description of drawings, like reference numerals may be used for like components.

### DETAILED DESCRIPTION OF EXEMPLARY EMBODIMENTS

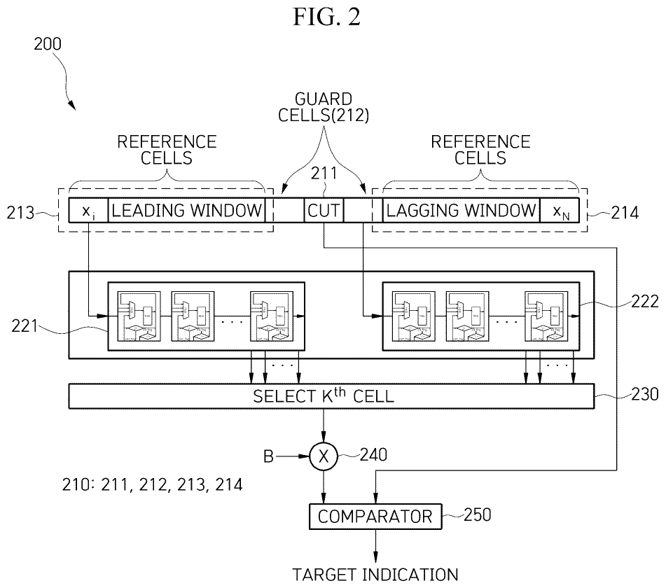

FIG. 2 is a configuration diagram of an ordered statistic-constant false alarm rate (OS-CFAR) device according to an exemplary embodiment.

Referring to FIG. 2, an OS-CFAR device 200 according to the exemplary embodiment includes a shift register 210, a first sorting shift block 221, a second sorting shift block 222, a selector 230, a multiplier 240, and a comparator 250.

According to the exemplary embodiment, the shift register 210 includes N cells each of which stores data. With a shift of a cell under test (CUT) 211, first and second reference windows 213 and 214 and guard windows 212 slide, and cells in the shift register 210 are sequentially selected. The shift register 210 may include the CUT 211, the guard windows 212, and the first and second reference windows 213 and 214. A data value stored in each cell may be the intensity (e.g., an amplitude value) of a signal received by a radar system.

Nearby cells adjacent to the CUT 211 are selected as the guard windows 212, which include a leading guard window and a lagging guard window on the left and right of the CUT 211.

The first and second reference windows 213 and 214 include a first reference cells (window) (leading reference window) 213 and a second reference cells (window) (lagging reference window) 214 which are on the left and right of the CUT 211 with the guard cells (windows) 212 interposed therebetween. Data values of the first reference window 213 and the second reference window 214 are sorted by the first sorting shift block 221 and the second sorting shift block 222, respectively.

According to the exemplary embodiment, when data included in the first reference window 213 is acquired, the first sorting shift block 221 sorts the acquired data values. When data values included in the second reference window 214 are acquired, the second sorting shift block 222 sorts the acquired data values.

In relation to this, the first and second sorting shift blocks 221 and 222 may include a number of unit blocks, each of which stores one piece of data, equal to a number of unit blocks of the first and second reference window 213 and 214. For example, when N/2 pieces of data are stored in each of the first and second reference windows 213 and 214, the first and second sorting shift blocks 221 and 222 may also sort N/2 data values from the first and second reference windows 213 and 214, respectively.

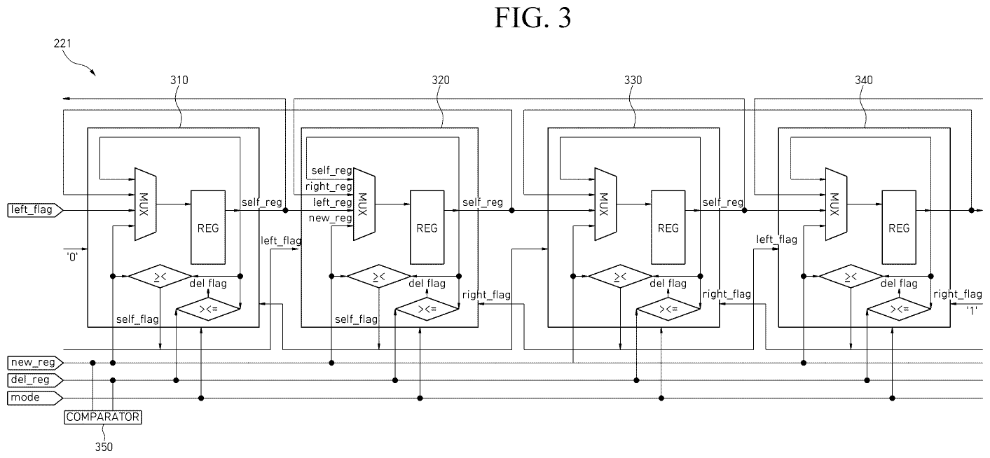

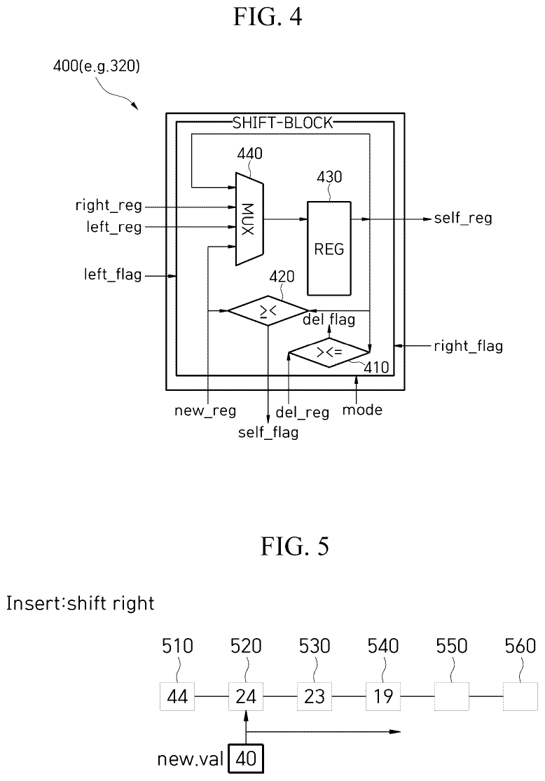

According to the exemplary embodiment, every time a new data value is added or the oldest data is removed in a previous sorted state, the first and second shift blocks 221 and 222 may shift a part that requires a shift and insert new data values into an empty space due to the shift. The first and second shift blocks 221 and 222 may remove the oldest data value in order of input. This will be described in detail below with reference to FIGS. 3 and 4.

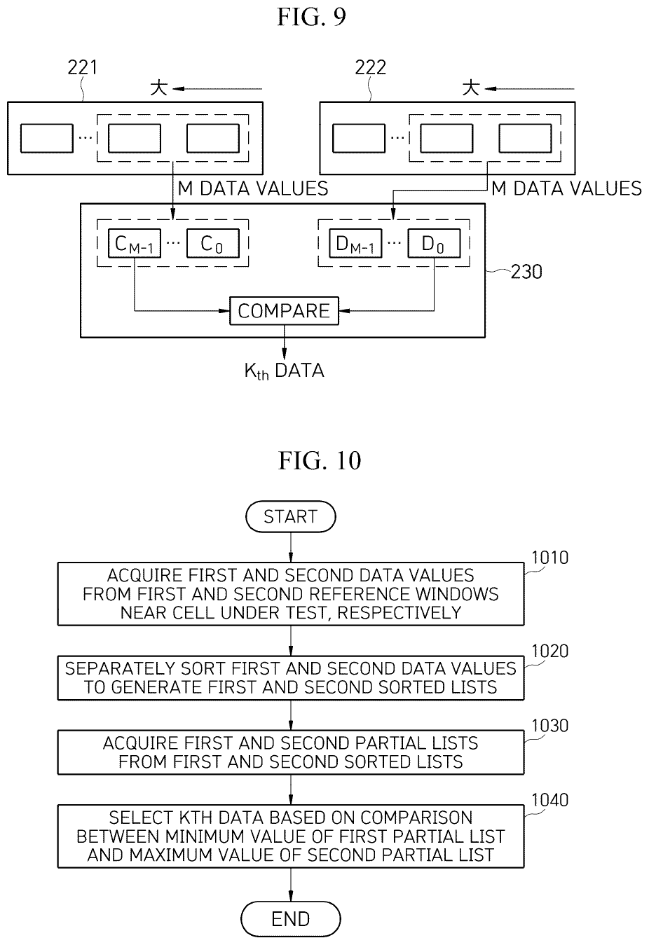

According to the exemplary embodiment, the selector 230 receives data values from each of the first sorting shift block 221 and the second sorting shift block 222 and selects a designated k^{th} data value. As the k^{th} data value, for example, a value at the (¾*N)^{th} position in a descending sorted list (which is known for the best detection performance of a radar system) may be used. In this case, the selector 230 may select a value at the (¾*N)^{th} position among data values sorted in descending order. When N equals 12 to 20, k may be 9 to 15. Since the values of 9 to 15 are positions from the forefront (the largest value) of the alignment, positions (hereinafter “M”) from the backend (the smallest value) of the alignment may be 6 to 4. In other words, when N equals 12 in two sorted lists corresponding to the first and second sorting shift blocks 221 and 222, M may be 4. When N equals 16, M may be 5, and when N equals 20, M may be 6. When N is larger than 20, M may be larger than 6. In this way, when M values beginning with the smallest value are taken from two sorted lists to detect M small values and detect the M^{th} value which is the largest of the M small values, it is possible to readily select the value of M. The process of the selector 230 selecting the k^{th} data value will be described below with reference to FIG. 9.

The multiplier 240 calculates a threshold by multiplying the k^{th} data value by a threshold coefficient B, and the comparator 250 compares the calculated threshold with the CUT 211.

According to the above-described exemplary embodiment, the first reference window 213 and the second reference window 214 are separated. Accordingly, when each of the reference windows 213 and 214 shifts, data is newly input to the forefront (the forefront of the first sorting shift block 221) and the middle (the forefront of the second sorting shift block 222) of the sorting shift blocks 221 and 222, and data to be deleted is in the middle (the backend of the first sorting shift block 221) and the backend (the backend of the second sorting shift block 222). In this regard, the shift register 210 has three states in total. First, all registers of the shift register 210 are empty in an initial state and then filled with data one by one (first state). Subsequently, some registers of the shift register 210 are filled with new data values, and there are data values to be deleted with shifts in the backend registers (second state). Finally, there is no more input data, and data stored in the shift register 210 is shifted and sequentially deleted one by one (third state). Data sorting by the first and second sorting shift blocks 221 and 222 according to the exemplary embodiment in the three states of the shift register 210 will be described below.

As described above, in the OS-CFAR device 200 according to the exemplary embodiment, OS-CFAR sorting shift blocks are formed as pipeline-structured hardware to sort the content of reference window cells to be sorted, and thus it is possible to incrementally sort data which is input one by one like an intuitive sorting method of humans.

In addition, the OS-CFAR device 200 according to the exemplary embodiment only inserts a new data value, and removes the oldest data after shifting the part that needs to be moved in a previous sorted state. Accordingly, it is possible to remarkably reduce the number of comparisons and a throughput for sorting and increase a processing rate.

FIG. 3 is a configuration diagram of a sorting shift block according to an exemplary embodiment, and FIG. 4 is a configuration diagram of unit blocks in a sorting shift block according to an exemplary embodiment. FIG. 3 illustrates the case where a sorting shift block 300 (e.g., 221) includes four unit blocks. However, the present invention is not limited thereto.

Referring to FIG. 3, the sorting shift block (e.g., 221 or 222) may include a plurality of unit blocks 310, 320, 330, and 340 and an external comparator 350.

According to the exemplary embodiment, the external comparator 350 may compare a new data value with a data value to be deleted and output a mode signal in accordance with the comparison result.

For example, the external comparator 350 may output the mode signal indicating a first mode in which a new data value is equal to a data value to be deleted, a second mode in which a new data value exceeds a data value to be deleted, or a third mode in which a new data value is smaller than a data value to be deleted. Here, a data value to be deleted del_val may be processed in a first-in first-out (FIFO) manner and may be a value of data at the rightmost position (data at a position to be deleted next by a shift register operation) in each reference window (e.g., 213). The mode signal may be simultaneously provided to the plurality of unit blocks 310, 320, 330, and 340.

The plurality of unit blocks 310, 320, 330, and 340 may be connected in a pipeline structure and may receive new data values and data values to be deleted in parallel.

Referring to FIG. 4, each unit block 400 according to the exemplary embodiment may include a register 430, a first comparator 410, a second comparator 420, and a multiplexer 440. FIG. 4 illustrates the second unit block 320, but the other unit blocks also operate in a like manner.

The first comparator 410 may compare a new data value with an internal data value of the register 430. The first comparator 410 compares a current register value (internal data value) self_reg with a new data value new_reg and outputs a first signal self_flag corresponding to the comparison result. For example, using one bit value, the first (comparison) signal may represent a state in which the current register value is the new data value or less (new_reg>=self_reg) and a state in which the current register value exceeds the new data value (new_reg<self_reg).

The first comparator 410 may generate the first signal (hereinafter, “self_flag”) which represents whether the new data value is the internal data value or more and provide the first signal to a unit block (e.g., 310 of FIG. 3) and a unit block (e.g., 330 of FIG. 3) on the left and right of each unit block 400. For example, the first signal self_flag of each unit block 400 is connected to right_flag of a unit block on the left of the unit block 400 and left_flag of a unit block on the right. As an example, self_flag of the second unit block 320 is connected to right_flag of the first unit block 310 on the left of the second unit block 320 and left_flag of the third unit block 330 on the right.

The second comparator 420 may compare the current register value self_reg with the data value to be deleted del_val and output a second (comparison) signal del_flag corresponding to the comparison result. The second signal may use a 2-bit value to distinctively represent a state in which the data to be deleted is equal to the current register value (del_reg==self_reg), a state in which the data to be deleted is larger than the current register value (del_reg>self_reg), and a state in which the data to be deleted is smaller than the current register value (del_reg<self_reg). The first signal and the second signal may be used as control signals for the multiplexer 440.

The multiplexer 440 may receive the comparison results of the external comparator 350, the first comparator 410, and the second comparator 420 as control signals. In accordance with the control signals, the multiplexer 440 may selectively store one of the internal data value of the register 430, the new data value, and a data value of the unit block on the left or right of the unit block in the register 430.

In accordance with an input control signal, the multiplexer 440 may maintain the internal data value self_reg stored in the register 430 or replace the internal data value self_reg with a left register value left_reg (internal data stored in the left unit block), a right register value right_reg, or the new data value new_reg. The control signal may be set by outputs of the first comparator 410 and the second comparator 420.

A self-reg port of each unit block 400 is connected to a right_reg port of a unit block on the left of the unit block 400 and left_reg port of a unit block on the right. For example, the self_reg port of the second unit block 320 is connected to the right_reg port of the first unit block 310 on the left of the second unit block 320 and the left_reg port of the third unit block 330 on the right.

The mode signal simultaneously input to the unit blocks 400 may represent one of three modes in accordance with a comparison result between the new data value and the data to be deleted. The three modes include three state modes, for example, (new_reg==del_reg), (new_reg>del_reg), and (new_reg<del_reg).

A constant value of 0 which represents that a register value of a unit block on the left of the first unit block 310 is always larger than new_reg (new_reg<left_reg) is applied to the left_flag port of the first unit block 310 which is at the left end. A constant value of 1 which represents that a register value of a unit block on the right is always smaller than new_reg (new_reg>right_reg) is applied to the right_flag port of the fourth unit block 340 which is at the right end.

Operations of a unit block will be described below with reference to FIGS. 5 to 8.

FIG. 5 is a conceptual diagram illustrating an operation of a sorting shift block in a first state of a shift register. In the first state, only newly input data is in a sorting shift block. FIG. 5 illustrates the case where the sorting shift block includes six unit blocks 510, 520, 530, 540, 550, and 560 in total and a fifth new data value is input following four previous data inputs.

Internal values of a sorting shift block (e.g., 221) are empty (with an initial value (null or 0)) in an initial state, and new data values are simultaneously input to the unit blocks 510 to 560 at every clock.

When all the unit blocks in the sorting shift block are in the initial state before FIG. 5, a new data value is stored in the leftmost unit block.

As shown in FIG. 5, when some unit blocks 510 to 540 of the sorting shift block (e.g., 221) are filled with internal data values, each unit block 400 compares a new data value new_val with the internal data value. When the comparison result indicates that the internal data value exceeds the new data value, each unit block 400 maintains a previous state, and when the internal data value is the new data value or less, each unit block 400 shifts the internal data value to the right. The new data value is stored at a position at which the new data value is smaller than a data value stored in a right unit block and is larger than an internal data value of each unit block 400.

For example, the first unit block 510 has an internal data value larger than a new data value and thus maintains the internal data value. On the other hand, the second to sixth unit blocks 520 to 560 have internal data values of the new data value or less and thus shift the internal data values to the right by one unit block. In this way, the first to sixth unit blocks 510 to 560 can simultaneously maintain a previous state or shift an internal data value on the basis of comparison between an internal data value and a new data value. The fifth and sixth unit blocks 550 and 560 in which no internal data value is stored interpret the internal data value as 0.

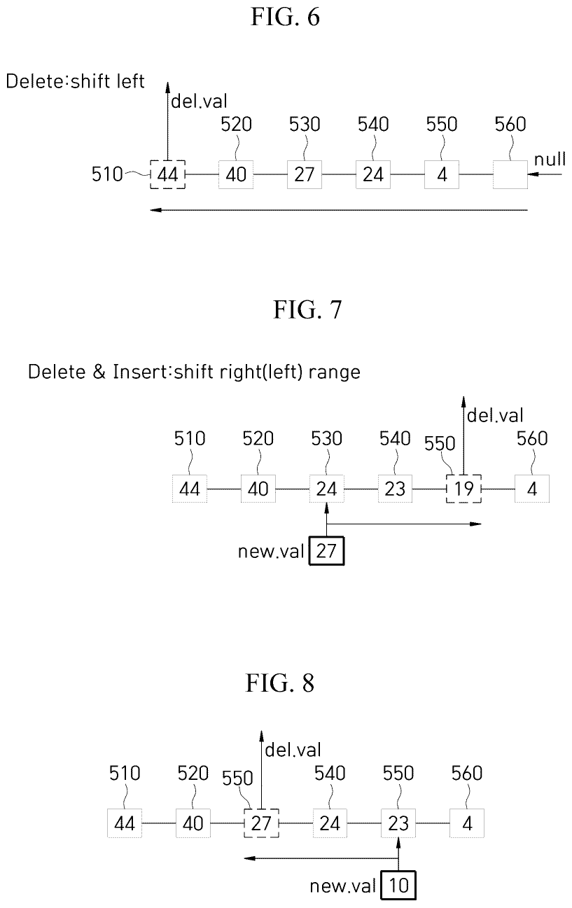

FIG. 6 is a conceptual diagram illustrating an operation of a sorting shift block in a third state of a shift register. In the third state, new data is not input to the shift register 210. At every clock, internal data values are shifted to the right by one unit block, and data at the end position is shifted to the guard windows 212 and deleted. Accordingly, no new data value is input to a sorting shift block (e.g., 221), and data is sequentially deleted in order of input at every clock.

The unit blocks 510 to 560 in the sorting shift block (e.g., 221) simultaneously receive a value to be deleted del_val, and each unit block (e.g., 510) compares an internal data value self_reg with the value to be deleted del_val. When the internal data value is smaller than the value to be deleted (del_val>self_reg), each of the unit blocks 510 to 560 shifts the internal data value to the left. Otherwise, each of the unit blocks 510 to 560 maintains the internal data value.

Here, the value to be deleted del_val may be processed in a FIFO manner and may be a value of data at the rightmost position (data at a position to be deleted next by a shift register operation) in each reference window (e.g., 213).

FIGS. 7 and 8 are conceptual diagrams illustrating operations of a sorting shift block in a second state of a shift register. The second state is a general state in which both new input data new_val and a data value to be deleted del_val are present. The second state corresponds to one of three cases: i) the case where the new data value new_val is equal to the data value to be deleted del_val (new_val==del_val), ii) the case where the new data value new_val is larger than the data value to be deleted del_val (new_val>del_val), and iii) the case where the new data value new_val is smaller than the data value to be deleted del_val (new_val<del_val).

First, when the new data value new_val is equal to the data value to be deleted del_val (new_val==del_val), each unit block 400 maintains a previous state without performing any operation.

As shown in FIG. 7, when the new data value is larger than the data value to be deleted (new_val<del_val), each unit block 400 selectively shifts the internal data value to the right in accordance with results of comparing the internal data value with the new data value and the data value to be deleted. Among the plurality of unit blocks 510 to 560, the third and fourth unit blocks 530 to 560 satisfying a first condition shift the internal data values to the right by one unit block. The first condition may require that an internal data value be a new data value or less and exceed a data value to be deleted. On the other hand, the first, second, and sixth unit blocks 510, 520, and 560 may maintain the internal data values. Through this operation, the new data value is stored in the third unit block 530 because the new data value is smaller than an internal data value left_reg of the second unit block 520 and is an internal data value self_reg of the third unit block 530 or more (left_reg>new_val && new_val>=self_reg).

As shown in FIG. 8, when the new data value is smaller than the data value to be deleted (new_val<del_val), the fourth and fifth unit blocks 540 and 550 satisfying a second condition among the plurality of unit blocks 510 to 560 may shift the internal data values to the left by one unit block. The second condition may require that an internal data value be smaller than data to be deleted and larger than a new data value (del_val>self_reg>new_val). Through this operation, the new data value is stored in the fifth unit block 550 corresponding to a position of which a right unit block has an internal data value (right_reg) smaller than the new data value and of which a current unit block has an internal data value larger than the new data value (self_reg>new_val && new_val>left_reg).

As described above, in the OS-CFAR device 200 according to the exemplary embodiment, pipeline-structured hardware sorting shift blocks are configured to sort the content of reference window cells to be sorted, and thus it is possible to incrementally sort data which is input one by one like the intuitive sorting method of humans. Therefore, without having to newly sort data every time a CUT changes, the OS-CFAR device 200 according to the exemplary embodiment only shifts a part that require a shift, inserts a new data value, and removes the oldest data every time the new data value is added or the oldest data is removed in a previous sorted state. Accordingly, it is possible to remarkably reduce a throughput for sorting.

FIG. 9 is a diagram illustrating a method of selecting a k^{th} data value through a selector according to an exemplary embodiment.

Referring to FIG. 9, according to the exemplary embodiment, the selector 230 may acquire first and second partial lists including M ((N/4)+1) values in descending order from minimum value of each of a first sorted list and a second sorted list that are respectively sorted by the first sorting shift block 221 and the second sorting shift block 222.

According to the exemplary embodiment, the selector 230 may compare whether the maximum value of one partial list among the first partial list and the second partial list is smaller than the minimum value of the other partial list, and select a k^{th} data value on the basis of the determination result.

According to the exemplary embodiment, when the maximum value of one partial list exceeds the minimum value of the other partial list, the selector 230 may select the maximum value of the partial list as a k^{th} data value.

According to the exemplary embodiment, when the maximum value of one partial list is the minimum value of the other partial list or less, the selector 230 may compare the second maximum value of the one partial list with the second minimum value of the other partial list. When the second maximum value of the one partial list is smaller than the second minimum value of the other partial list, the selector 230 may select the second minimum value of the other partial list as the k^{th} data value.

According to the exemplary embodiment, when the second maximum value of the one partial list exceeds the second minimum value of the other partial list, the selector 230 may repeat an operation of comparing the next maximum value of the one partial list with the next minimum value of the other partial list to select the k^{th} data value.

According to the exemplary embodiment, the selector 230 may not select the k^{th} data value while comparing descending maximum values of a first partial list with ascending minimum values of a second partial list. In this case, the selector 230 may perform operations for selecting the k^{th} data while comparing descending maximum values of the second partial list with ascending minimum values of the first partial list in reverse.

According to the exemplary embodiment, when a k^{th} data value satisfying a radar detection condition is not detected, the selector 230 may repeat comparing descending maximum values of a partial list with ascending minimum values of another partial list up to ((M/2)+1) times.

Selecting a k^{th} data value when a first partial list is (C_{M-1}, . . . , and C₀) and a second partial list is (D_{M-1}, . . . , and D₀), will be described below.

When the maximum value C_{M-1} of the first partial list is smaller than the minimum value D₀ of the second partial list, the selector 230 selects the whole first partial list C_{M-1}, . . . . C₀ as descending M groups of the first and second partial lists. The selector 230 may select (determine) the maximum value C_{M-1} in the selected groups as a k^{th} data value.

On the other hand, when the minimum value D₀ of the second partial list is the maximum value C_{M-1} of the first partial list or less, the selector 230 may compare the second maximum value C_{M-2} of the first partial list with the second minimum value D₁ of the second partial list. When the second maximum value C_{M-2} of the first partial list is smaller than the second minimum value D₁ of the second partial list, the selector 230 may select a group of M data values (C_{M-2}, . . . . C₀, and D₀) which includes a data value D₀ smaller than the second minimum value D₁ of the second partial list and other values C_{M-2}, . . . , and C₀ in ascending order from the second maximum value C_{M-2} of the first partial list.

When the second maximum value C_{M-2} of the first partial list is the second minimum value D₁ of the second partial list or more, the selector 230 may repeat an operation of comparing the next maximum value of the first partial list with the next minimum value of the second partial list to select a k^{th} data value. In this way, the selector 230 may repeatedly compare a maximum value of the first partial list in descending order with a minimum value of the second partial list in ascending order up to ((M/2)+1) times. For example, the selector 230 may compare a Cᵢ^{th} data value (i=M−1−j) of the first partial list with a Dⱼ^{th} data value (when M is an even number, j ranges from M−1 to (M/2)−1, but when M is an odd number, j ranges from M−1 to (M/2)) of the second partial list to select a k^{th} data value.

In this way, the selector 230 according to the exemplary embodiment may determine a k^{th} data value by comparing data values of the first and second sorting shift blocks 221 and 222 with each other a small number of times.

FIG. 10 is a flowchart illustrating an OS-CFAR algorithm execution method according to an exemplary embodiment.

Referring to FIG. 10, in operation 1010, the OS-CFAR device 200 may acquire first and second data values from the first and second reference windows 213 and 214 near a CUT in the shift register 210.

In operation 1020, the OS-CFAR device 200 may separately sort the acquired first and second data values to generate first and second sorted lists.

In operation 1030, the OS-CFAR device 200 may extract a first partial list and a second partial list from the first and second sorted lists, respectively. For example, when the number of data values in each of the first and second reference windows is N/2, the OS-CFAR device 200 may acquire the first partial list and the second partial list each of which has (N/4+1) data values in descending order of the first and second sorted lists.

In operation 1040, the OS-CFAR device 200 may select a k^{th} data value for determining the CUT, on the basis of a comparison result between the minimum value of the first partial list and the maximum value of the second partial list. For example, the OS-CFAR device 200 may compare the maximum value of one of the first and second partial lists with the minimum value of the other partial list to determine whether the maximum value of the partial list is smaller than the minimum value of the other partial list. When it is determined that the maximum value of the one partial list exceeds the minimum value of the other partial list, the OS-CFAR device 200 may select the maximum value of the partial list as the k^{th} data value.

Various embodiments of the present document and terms used therein are not intended to limit technical characteristics described in the present document to specific embodiments, and it should be understood that the present document includes various modifications, equivalents, or substitutions of the embodiments. In description of drawings, similar reference numerals may be used for similar or associated components. A singular form of a noun corresponding to an item may include one or more items unless the context clearly indicates otherwise. In the present document, expressions such as “A or B,” “at least one of A and B,” “at least one of A or B,” “A, B, or C,” “at least one of A, B, and C” and “at least one of A, B, or C” may include any one of or all possible combinations of items listed together in a corresponding one of the expressions. Terms such as “1^{st},” “2^{nd},” “first,” “second,” and the like may be used to simply distinguish a corresponding component from another, and do not limit the components in another aspect (e.g., importance or order). When a certain (e.g., first) component is referred to, with or without the term “functionally” or “communicatively,” as “coupled” or “connected” to another (e.g., second) component, it means that the certain component may be coupled with the other component directly (e.g., by wire), wirelessly, or via a third component.

As used herein, the term “module” may include a unit implemented in hardware, software, or firmware and may interchangeably be used with other terms, for example, “logic,” “logic block,” “part,” and “circuit.” A module may be a single integral component or a minimum unit or part thereof that performs one or more functions. For example, according to an embodiment, a module may be implemented in the form of an application-specific integrated circuit (ASIC).

Various embodiments of the present document may be implemented as software (e.g., a program) including one or more instructions that are stored in the storage medium (e.g., an internal memory or an external memory) that is readable by a machine (e.g., an electronic device). For example, a processor (e.g., the selector 230 or the sorting shift block (e.g., 221) of FIG. 2) of a device (e.g., the OS-CFAR device 200) may invoke at least one of the one or more stored instructions from the storage medium and execute the at least one invoked instruction. This allows the machine to be operated to perform at least one function in accordance with the at least one invoked instruction. The one or more instructions may include code generated by a compiler or code executable by an interpreter. The machine-readable storage medium may be provided in the form of a non-transitory storage medium. Here, the term “non-transitory” simply means that the storage medium is a tangible device and does not include a signal (e.g., an electromagnetic wave), but this term does not distinguish between a case where data is semi-permanently stored in the storage medium and a case where data is temporarily stored in the storage medium.

According to an embodiment, methods according to various embodiments set forth herein may be included and provided in a computer program product. The computer program product may be traded as a product between a seller and buyer. The computer program product may be distributed in the form of a machine-readable storage medium (e.g., a compact disc (CD) read-only memory (ROM)) or distributed (e.g., downloaded or uploaded) online via an application store (e.g., PlayStore™) or between two user devices (e.g., smartphones) directly. When distributed online, at least a part of the computer program product may be temporarily generated or at least temporarily stored in a machine-readable storage medium such as a memory of the manufacturer's server, an application store server, or a relay server.

Components according to various embodiments of the present document may be implemented in the form of software or hardware, such as a digital signal processor (DSP), a field programmable gate array (FPGA), or an ASIC, and perform certain roles. The term “components” is not limited to software or hardware, and each component may be configured to be in an addressable storage medium or to reproduce one or more processors. Examples of components may include software components, object-oriented software components, class components, task components, processes, functions, attributes, procedure, subroutines, segments of program code, drivers, firmware, microcode, circuits, data, databases, data structures, tables, arrays, and variables.

According to various embodiments, each (e.g., a module or a program) of the foregoing components may include a single entity or multiple entities. According to various embodiments, one or more of the foregoing components or operations may be omitted, or one or more other components or operations may be added. Alternatively or additionally, a plurality of components (e.g., modules or programs) may be integrated into a single component. In such a case, the integrated component may still perform one or more functions of each of the plurality of components in the same manner as or a similar manner to a corresponding one of the plurality of components before the integration. According to various embodiments, operations performed by a module, a program, or another component may be carried out sequentially, in parallel, repeatedly, or heuristically, one or more of the operations may be executed in a different order or omitted, or one or more other operations may be added.

According to various embodiments disclosed in the present document, it is possible to sort data using a pipeline-structured hardware device.

Further, according to various embodiments disclosed in the present document, it is possible to determine k^{th} data in data of a plurality of sorting blocks through a small number of comparisons. In addition, various effects which are identified directly or indirectly from the present document can be provided.

What is claimed is:

1. A sorting shift register comprising:
a plurality of unit blocks connected in a pipeline structure and configured to receive a new data value and a data value to be deleted in parallel; and
an external comparator configured to compare the new data value and the data value to be deleted,
wherein each of the unit blocks comprises:
a register;
a first comparator configured to compare the new data value with an internal data value of the register;
a second comparator configured to compare the data value to be deleted with the internal data value; and
a multiplexer configured to selectively store, in the register, one of the internal data value, the new data value, and a data value of a unit block on a left or right of the unit block in accordance with comparison results of the external comparator, the first comparator, and the second comparator.

2. The sorting shift register of claim 1, wherein the external comparator generates an output signal indicating one of a first mode in which the new data value is equal to the data value to be deleted, a second mode in which the new data value exceeds the data value to be deleted, and a third mode in which the new data value is smaller than the data value to be deleted, and provides the output signal to the plurality of unit blocks.

3. The sorting shift register of claim 1, wherein the first comparator generates a first signal indicating whether the new data value is the internal data value or more, and provides the first signal to the multiplexer, the unit block on the left, and the unit block on the right.

4. The sorting shift register of claim 1, wherein the second comparator generates a second signal indicating whether the data value to be deleted is equal to, larger than, or smaller than the internal data value, and provides the second signal to the multiplexer.

5. The sorting shift register of claim 1, wherein, when the new data value is equal to the data value to be deleted, the unit blocks maintain the internal data value.

6. The sorting shift register of claim 1, wherein, when the new data value exceeds the data value to be deleted, each of the unit blocks determines whether the internal data value satisfies a first designated condition, and
when the internal data value satisfies the first designated condition, each of the unit blocks shifts the internal data value to the unit block on the right.

7. The sorting shift register of claim 6, wherein, when the internal data value does not satisfy the first designated condition, in a first case in which the new data value is the internal data value or less and smaller than an internal data value of the unit block on the left, each of the unit blocks stores the new data value in the register, and
in a case other than the first case, each of the unit blocks maintains a previous state.

8. The sorting shift register of claim 6, wherein the first designated condition requires that the internal data value is the new data value or less and exceed the data value to be deleted.

9. The sorting shift register of claim 1, wherein, when the new data value is smaller than the data value to be deleted, each of the unit blocks determines whether the internal data value satisfies a second designated condition, and
when the internal data value satisfies the second designated condition, each of the unit blocks shifts the internal data value to the unit block on the left.

10. The sorting shift register of claim 9, wherein, when the internal data value does not satisfy the second designated condition, in a first case in which the new data value is larger than the internal data value and smaller than an internal data value of the unit block on the right, each of the unit blocks stores the new data value in the register, and
in a case other than the first case, each of the unit blocks maintains a previous state.

11. The sorting shift register of claim 9, wherein the second designated condition requires that the internal data value be smaller than the data value to be deleted and larger than the new data value.

12. The sorting shift register of claim 1, wherein, when the internal data value is the new data value or less in a mode in which the data value to be deleted does not exist but the new data value exists, each of the unit blocks shifts the internal data value to the unit block on the right.

13. The sorting shift register of claim 12, wherein each of the unit blocks further compares the new data value with data values stored in the unit block on the right and the unit block on the left, and stores the new data value in the register when the new data value is the data value stored in the unit block on the right or less and exceeds the data value stored in the unit block on the left.

14. The sorting shift register of claim 1, wherein, when the internal data value is the new data value or less in a mode in which the data value to be deleted does not exist, but the new data value exists, each of the unit blocks shifts the internal data value to the unit block on the right, and
when the new data value is the internal data value or less and exceeds a data value stored in the unit block on the left in the mode, each of the unit blocks stores the new data value in the register.

15. The sorting shift register of claim 1, wherein, when the internal data value is smaller than the data value to be deleted in a mode in which the new data value does not exist but the data value to be deleted exists, each of the unit blocks shifts the internal data value to the unit block on the left.

16. An ordered statistic (OS)-constant false alarm rate (CFAR) device comprising:
a shift register configured to store more than N data values received by a radar;
a first sorting shift block configured to generate a first sorted list by sorting N/2 data values from a first reference window near a cell under test (CUT) in the shift register;
a second sorting shift block configured to generate a second sorted list by sorting N/2 data values from a second reference window near the CUT; and
a selector configured to select a k^{th} data value for determining the CUT on the basis of a result of comparing a minimum value and a maximum value respectively included in a first partial list of the first sorted list and a second partial list of the second sorted list.

17. The OS-CFAR device of claim 16, wherein the selector acquires the first partial list and the second partial list each of which respectively includes N/4 data values of the first and second sorted list in descending order,
compares a maximum value of one partial list of the first partial list and the second partial list with a minimum value of the other partial list to determine whether the maximum value is smaller than the minimum value, and
selects the maximum value of the one partial list as the k^{th} data value when the maximum value of the one partial list exceeds the minimum value of the other partial list.

18. The OS-CFAR device of claim 17, wherein, when the maximum value of the one partial list is the minimum value of the other partial list or less, the selector compares a second maximum value of the one partial list with a second minimum value of the other partial list to determine whether the maximum value is smaller than the minimum value,
when the second maximum value of the one partial list is smaller than the second minimum value of the other partial list or less, the selector selects a group including data values of the one partial list in ascending order from the second maximum value and including data values of the other partial list in descending order from the second minimum value, and
the selector selects a maximum value of the selected group as the k^{th} data value.

19. The OS-CFAR device of claim 17, wherein, when a second maximum value of the one partial list is a second minimum value of the other partial list or less, the selector repeats an operation of comparing a next maximum value of the one partial list with a next minimum value of the other partial list to select the k^{th} data value.

20. An ordered statistic (OS)-constant false alarm rate (CFAR) control method comprising:
acquiring first and second data values from first and second reference windows near a cell under test (CUT) in a shift register;
separately sorting the acquired first and second data values to generate first and second sorted lists;
extracting a first partial list and a second partial list from the first and second sorted lists, respectively; and
selecting a k^{th} data value for determining the CUT on the basis of a comparison result between a minimum value of the first partial list and a maximum value of the second partial list.
